(19) United States
(12) Patent Application Publication
(10) Pub. No.: US 2024/0342832 A1
(43) Pub. Date: Oct. 17, 2024

(54) PROCESSING METHOD AND PROCESSING APPARATUS FOR WORKPIECE

(71) Applicant: DISCO CORPORATION, Tokyo (JP)

(72) Inventors: Tsubasa HIROSE, Tokyo (JP); Hiroshi MORIKAZU, Tokyo (JP)

(21) Appl. No.: 18/625,388

(22) Filed: Apr. 3, 2024

(30) Foreign Application Priority Data
Apr. 17, 2023 (JP) 2023-066957

(51) Int. Cl. B23K 26/38; B23K 26/03; B23K 26/0622; B23K 101/40

(52) U.S. Cl. CPC B23K 26/38; B23K 26/03; B23K 26/0622; B23K 2101/40

(57) ABSTRACT

A processing method for a workpiece includes applying to the workpiece a pulsed laser beam that causes ablation to thereby generate plasma light and generate a first distribution pattern, the beam having a wavelength and intensity of light intrinsic to the workpiece substance, the beam being used to find and set appropriate processing conditions for processing the workpiece; recording the first distribution pattern and the processing conditions in a linked manner; applying the beam to the workpiece to generate plasma light; generating a second distribution pattern including a wavelength and intensity of light intrinsic to the workpiece substance, according to the plasma light; collating the second distribution pattern and the first distribution pattern to thereby select a third distribution pattern having a degree of similarity in a predetermined range; and processing the workpiece in reference to processing conditions linked to the third distribution pattern.

### BACKGROUND OF THE INVENTION

### Field of the Invention

The present invention relates to a processing method and a processing apparatus for a workpiece.

### Description of the Related Art

A wafer having a front surface formed with a plurality of devices such as integrated circuits (ICs) and large scale integration (LSI) circuits in a state of being partitioned by a plurality of intersecting streets is subjected to grinding of its back surface by a grinding apparatus and formed to have a desired thickness, after which the wafer is divided into individual device chips by a cutting apparatus or a laser processing apparatus, and the thus divided device chips are used for electric apparatuses such as mobile phones and personal computers.

The grinding apparatus includes a holding unit that holds the wafer, a grinding unit having, in a rotatable manner, a grinding wheel that grinds the wafer held by the holding unit, a feeding mechanism that grinding feeds the grinding unit relative to the wafer held by the holding unit, and a thickness measuring instrument that measures the thickness of the wafer, and the grinding apparatus can grind the wafer to a desired thickness (see, for example, Japanese Patent Laid-open No. 2006-021264).

The cutting apparatus includes a holding unit that holds the wafer, a grinding unit having, in a rotatable manner, a grinding wheel that grinds the wafer held by the holding unit, a processing feeding mechanism that subjects the cutting unit and the holding unit to relative processing feed, and an alignment unit that images the wafer to be processed and detects the street, and the cutting apparatus can divide the wafer into the individual device chips highly accurately (see, for example, Japanese Patent Laid-open No. Hei 11-026402).

The laser processing apparatus includes a holding unit that holds the wafer, a laser applying unit that applies a laser beam to the wafer held by the holding unit and processes the wafer, a processing feeding mechanism that subjects the laser applying unit and the holding unit to relative processing feed, and an alignment unit that images the wafer to be processed and detects the street, and the laser processing apparatus can divide the wafer into the individual device chips highly accurately (see, for example, Japanese Patent Laid-open No. 2004-322168).

### SUMMARY OF THE INVENTION

A workpiece to be processed by the above-mentioned processing apparatus, for example, a silicon substrate constituting a wafer formed with devices such as ICs and LSI circuits is doped with an impurity such as phosphor (P), arsenic (As), antimony (Sb), boron (B), aluminum (Al), or gallium (Ga), and the silicon substrate classified as the same kind of blank material is varied in its characteristics such as hardness, brittleness, and flexibility according to the differences in the kind and amount of the impurity with which the substrate is doped, an ingot manufacturing method, and the like. Hence, even in the case of the workpieces formed of the same kind of blank material, the previous processing conditions cannot be applied without any change in the processing such as grinding, cutting, and laser processing, making it necessary to search for and/or adjust the appropriate processing conditions each time of the processing, and causing poor productivity and troublesome work.

Accordingly, it is an object of the present invention to provide a processing method and a processing apparatus for a workpiece by which it is possible to dissolve the problem that processing conditions must be searched for each time the characteristics of the workpiece are changed, causing poor productivity and troublesome work.

In accordance with an aspect of the present invention, there is provided a processing method for a workpiece, including a distribution pattern generating step of applying, to the workpiece, such a pulsed laser beam as to cause ablation to generate plasma light and generating a first distribution pattern including a wavelength and intensity of light intrinsic of a substance constituting the workpiece, according to the plasma light, a processing condition setting step of finding and setting appropriate processing conditions for processing the workpiece, a recording step of recording the first distribution pattern generated by the distribution pattern generating step and the processing conditions set by the setting step in a linked manner, a distribution pattern selecting step of applying, to the workpiece to be processed, such a pulsed laser beam as to generate ablation to generate plasma light, generating a second distribution pattern including a wavelength and intensity of light intrinsic of the substance constituting the workpiece, according to the plasma light, and collating the second distribution pattern and the first distribution pattern recorded in the recording step and selecting a third distribution pattern having a degree of similarity in an allowable range, and a processing step of processing the workpiece in reference to processing conditions linked to the third distribution pattern selected in the distribution pattern selecting step.

Preferably, the workpiece is a plate-shaped workpiece. Preferably, in the distribution pattern generating step, the pulsed laser beam is applied to an unnecessary part of the workpiece.

In accordance with another aspect of the present invention, there is provided a processing apparatus for a workpiece, including a distribution pattern generating unit that applies, to the workpiece, such a pulsed laser beam as to cause ablation to generate plasma light and generates a first distribution pattern including a wavelength and intensity of light intrinsic of a substance constituting the workpiece, according to the plasma light, a recording section that records the first distribution pattern of the workpiece generated by the distribution pattern generating unit and appropriate processing conditions for processing the workpiece in a linked manner, a distribution pattern selecting section that generates a second distribution pattern of the workpiece to be processed by the distribution pattern generating unit and collates the second distribution pattern and the first distribution pattern recorded in the recording section to thereby select a third distribution pattern having a degree of similarity in an allowable range, and a processing unit that processes the workpiece in reference to processing conditions linked to the third distribution pattern selected by the distribution pattern selecting section.

Preferably, the workpiece is a plate-shaped workpiece. Preferably, the distribution pattern generating unit is means for applying the pulsed laser beam to an unnecessary part of the workpiece.

According to the processing method for the workpiece of the present invention, the appropriate processing conditions varying according to the substance-basis characteristics of the blank material constituting the workpiece are set, and the processing is carried out under the appropriate processing conditions, so that the problem that the processing conditions must be searched for each time the characteristics of the workpiece are changed, causing poor productivity and troublesome work, is dissolved.

According to the processing apparatus of the present invention, the appropriate processing conditions varying according to the substance-basis characteristics of the blank material constituting the workpiece are set, and the processing is carried out under the appropriate processing conditions, so that the problem that the processing conditions must be searched for each time the characteristic of the workpiece are changed, causing poor productivity and troublesome work, is dissolved.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is a perspective view of the whole part of a cutting apparatus according to the present embodiment;

FIG. 2 is a block diagram depicting an optical system of a distribution pattern generating unit that is mounted to the cutting apparatus depicted in FIG. 1;

FIG. 3 is a conceptual diagram depicting the configuration of a recording section disposed in a controller of the cutting apparatus depicted in FIG. 1; and

FIG. 4 is a perspective view depicting an embodiment of a distribution pattern generating step.

### DETAILED DESCRIPTION OF THE PREFERRED EMBODIMENT

An embodiment concerning a processing method and a processing apparatus for a workpiece configured based on the present invention will be described in detail below with reference to the attached drawings.

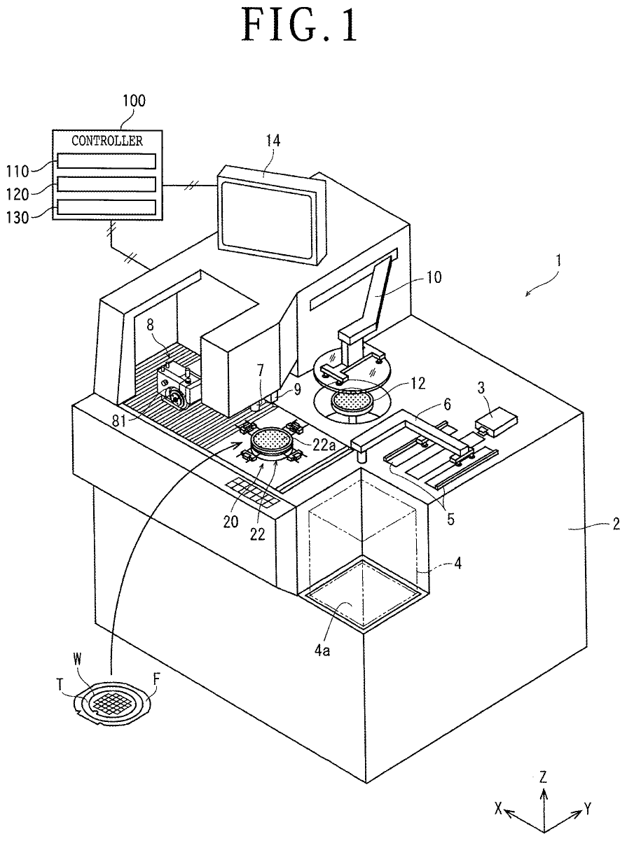

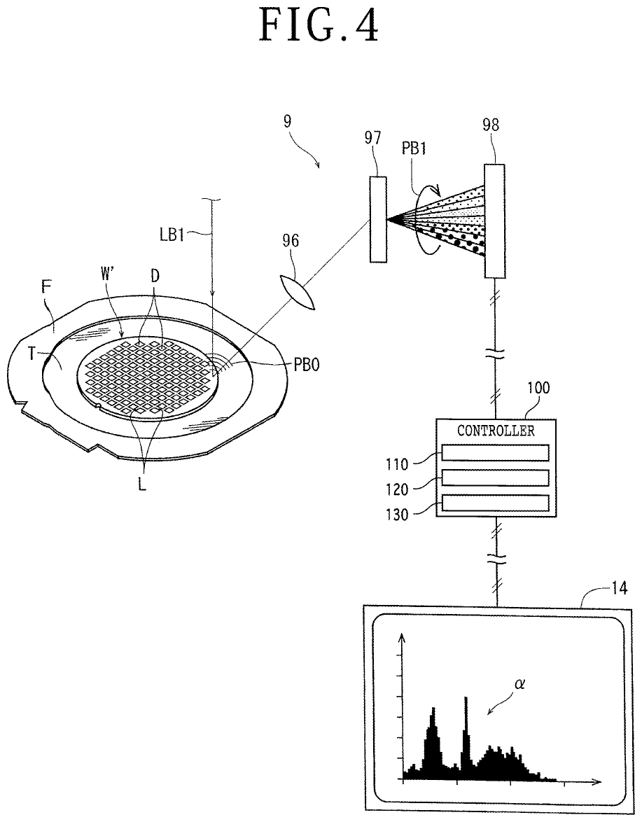

FIG. 1 depicts a perspective view of the whole part of a cutting apparatus 1 as an example of the embodiment of the processing apparatus according to the present invention. The workpiece to be processed by the cutting apparatus 1 is a plate-shaped body, for example, a wafer W of a semiconductor formed of silicon (Si) that is formed with a plurality of devices D on a front surface thereof partitioned by a plurality of streets L (see also FIG. 4), and that is supported by an annular frame F through a pressure sensitive adhesive tape T.

The cutting apparatus 1 includes a substantially rectangular parallelepiped housing 2, a cassette 4 mounted on a cassette table 4a of the housing 2, a conveying-in/out mechanism 3 that sucks the wafer W supported by the annular frame F from the cassette 4 and conveys out the wafer W onto a tentative placing table 5, a holding unit 20 including a chuck table 22 that holds the wafer W conveyed out onto the tentative placing table 5, a conveying mechanism 6 having a slewing arm that conveys the wafer W onto the chuck table 22, a cutting unit 8 including a cutting blade 81 disposed as a processing unit that applies cutting to the wafer W held on a holding surface 22a of the chuck table 22, an alignment unit 7 for imaging the wafer W held on the chuck table 22 and detecting a region to be cut by the cutting unit 8, a cleaning conveying-out unit 10 that conveys the wafer W from a conveying-in/out position where the chuck table 22 is located in FIG. 1 to a cleaning apparatus 12, a distribution pattern generating unit 9 (described in detail later) that generates a distribution pattern including a wavelength and intensity of light intrinsic of a substance constituting the wafer W, a display unit 14, and a controller 100 to which the operating sections are connected. Displayed on the display unit 14 are information and processing conditions and the like detected by the alignment unit 7 and the distribution pattern generating unit 9, and a display screen of the display unit 14 is configured by a touch panel, whereby it is possible to set the processing conditions and to instruct start and stop of processing by touching the display screen.

A feeding mechanism that moves the chuck table 22 constituting the holding unit 20 and the cutting unit 8 relative to each other is disposed inside the housing 2. The feeding mechanism includes an X-axis feeding mechanism for performing processing feeding in an X-axis direction; a Y-axis feeding mechanism for relative indexing feeding of the chuck table 22 and the cutting unit 8 in a Y-axis direction orthogonal to the X-axis direction, a Z-axis feeding mechanism for relative cutting-in feeding of the chuck table 22 and the cutting unit 8 in a Z-axis direction orthogonal to the X-axis direction and the Y-axis direction, and a rotational drive mechanism for rotating the chuck table 22 (all of these are omitted in illustration). The holding surface 22a of the chuck table 22 is formed of a gas-permeable blank material, and is connected to unillustrated suction means, such that, by operating the suction means, a negative pressure can be generated at the holding surface 22a and the wafer W can be held under suction on the holding surface 22a.

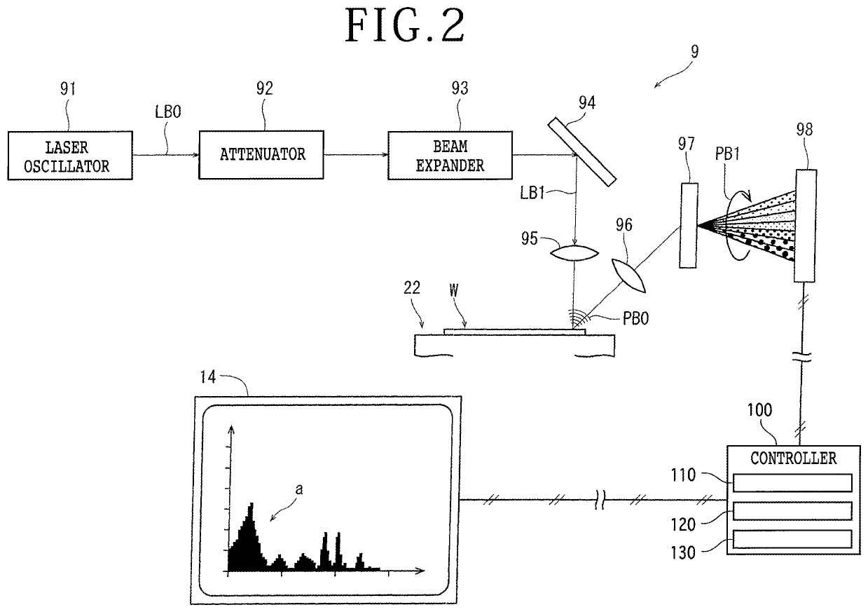

The distribution pattern generating unit 9 is disposed in the vicinity of the alignment unit 7 in the Y-axis direction, and includes an optical system depicted in FIG. 2. The optical system is accommodated in the housing 2, and includes, for example, a laser oscillator 91 that emits a pulsed laser beam LB0 of such a wavelength as to be absorbed in the silicon substrate constituting the wafer W and to cause ablation, an attenuator 92 that adjusts the output of the pulsed laser beam LB0 emitted by the laser oscillator 91, a beam expander 93 that converts a pulsed laser beam LB1 having been adjusted in output by the attenuator 92 into parallel light with a predetermined magnification, a reflective mirror 94 that reflects the pulsed laser beam LB1 applied from the beam expander 93, a condenser lens 95 that concentrates the pulsed laser beam LB1 having been changed in optical path by the reflective mirror 94; a condenser lens 96 that concentrates plasma light PB0 generated by the pulsed laser beam LB1 having been concentrated by the condenser lens 95 and applied to the wafer W, a diffraction grating 97 that spectrally disperses the plasma light PB0 having been concentrated by the condenser lens 96 into its components by wavelength, and a line sensor 98 that can receive spectra PB1 having been spectrally dispersed by wavelength by the diffraction grating 97 and can detect the light intensity by wavelength according to the positions. Note that the spectra PB1 depicted in FIG. 2 are expressed at seven stages of color changes by wavelength for convenience of description, but, in reality, intermediate colors are also included, and color changes according to wavelengths are at further multiple stages. The distribution pattern generating unit 9 of the present invention is not limited to being formed in the above-described configuration; for example, the beam expander 93 may be configured by a collimator lens, and the diffraction grating 97 may be configured by a prism.

The controller 100 is configured by a computer, and includes a central processing unit (CPU) that performs arithmetic processing according to a control program, a read only memory (ROM) that stores the control program and the like, a random access memory (RAM) that temporarily stores detected values, arithmetic processing results, and the like, an input interface, and an output interface (details of these are omitted in illustration). The controller 100 includes a distribution pattern generating section 110, a recording section 120, and a distribution pattern selecting section 130 which will be described later. According to drive signals instructed from the controller 100, the operating sections of the cutting apparatus 1 are controlled.

Signals of light intensity by wavelength which are outputted from the line sensor 98 are sent to the controller 100, in which a distribution pattern “a” as displayed on the display unit 14 of FIG. 2 is generated by the distribution pattern generating section 110 that is disposed in the controller 100 and that is functioning as a part of the distribution pattern generating unit 9 and is stored in an appropriate one of the memories. Note that the axis of abscissas of the distribution pattern depicted in FIG. 4 represents a wavelength (200 to 900 nm), and the axis of ordinates represents light intensity (for example, voltage values detected by the line sensor 98) corresponding to wavelengths. As depicted in FIG. 1, the distribution pattern generating unit 9 is disposed in the vicinity of the alignment unit 7 in the Y-axis direction. Thus, the above-mentioned pulsed laser beam LB1 applied by the distribution pattern generating unit 9 is applied to a region of a peripheral end part of the wafer W held by the chuck table 22, that is, an unnecessary part of the wafer W where the devices and the like are not disposed and which is discarded after the wafer W is divided into device chips. Note that the above-mentioned distribution pattern “a” corresponds to the amounts and combinations of phosphor (P), arsenic (As), antimony (Sb), boron (B), aluminum (Al), gallium (Ga), and the like with which the silicon substrate forming the wafer W depicted in the figure is doped, an ingot manufacturing method, and the like, and is a distribution pattern intrinsic of the substance constituting the wafer W.

In the controller 100, the recording section 120 is disposed. The recording section 120 is a recording section that records the distribution patterns which are generated by the above-mentioned distribution pattern generating unit 9 and which are based on the wafer W and appropriate processing conditions for processing the wafer W in a linked manner, and that is configured by a physical memory. A step of recording the distribution patterns based on the wafer W and the appropriate processing conditions for processing the wafer W in the linked manner will be described in detail later.

Further, the controller 100 includes the distribution pattern selecting section 130 that generates, by the above-mentioned distribution pattern generating unit 9, the distribution pattern according to the wafer W to be processed and collates the distribution pattern and the distribution patterns having been recorded in the recording section 120 to thereby select a distribution pattern having a degree of similarity in a predetermined range. In the cutting apparatus 1 of the present embodiment, processing conditions to be used at the time of processing the wafer W by the processing unit for processing the wafer W, that is, the cutting unit 8, are set according to the processing conditions linked to the distribution pattern selected by the distribution pattern selecting section 130. A step of setting the processing conditions will also be described in detail later.

The cutting apparatus 1 is configured substantially as described above, and the processing method for the workpiece in the present embodiment that is carried out by the cutting apparatus 1 will be described below.

At the time of carrying out the processing method for the workpiece according to the present embodiment, first, the wafer W to be the workpiece is prepared, as has been described with reference to FIGS. 1 and 2. Then, the wafer W is mounted on and held under suction by the holding surface 22a of the chuck table 22, and the wafer W is positioned directly under the distribution pattern generating unit 9. Next, by operating the above-mentioned distribution pattern generating unit 9, a pulsed laser beam LB1 that causes ablation is applied to a front surface of the wafer W to thereby cause ablation, generating plasma light PB0. In the case where the wafer W used in this instance is formed with devices, the pulsed laser beam LB1 applied from the distribution pattern generating unit 9 is applied to a peripheral surplus region of the wafer W where the devices are not formed. As a result, based on the wavelength and light intensity of each wavelength of the spectra PB obtained by spectrally dispersing the thus generated plasma light PB0, a distribution pattern “a” including the wavelength and intensity of light intrinsic of the substance constituting the workpiece, as displayed on the display unit 14 in FIG. 2, is generated (distribution pattern generating step).

In carrying out the above-described distribution pattern generating step, the processing conditions for generating the plasma light PB0 by applying the pulsed laser beam LB1 by the distribution pattern generating unit 9 are set, for example, as follows.
Wavelength: 355 nm
Pulse width: 10 ps
Repetition frequency: 10 kHz
Average output: 0.3 W
Number of shots: 1,000 shots

When the above-described distribution pattern generating step has been carried out, the distribution pattern “a” is temporarily stored in the distribution pattern generating section 110. Next, in order to find appropriate processing conditions for cutting the wafer W, test cutting of the peripheral surplus region of the wafer W is carried out.

The processing conditions at the time of carrying out the above-mentioned test cutting are modified and/or adjusted, for example, within the following set ranges. Note that the processing conditions indicated below are merely an example, and adjustments may be performed in ranges including other processing conditions.
Type of cutting blade: Type 1 to Type 10
Spindle rotational speed: 5,000 to 65,000 rpm
Cutting water: 1 to 3 L/min
Feed rate in X-axis direction: 10 to 100 mm/s

When the processing conditions at the time of processing by the cutting unit 8 have been modified in the ranges of the processing conditions described above and the wafer W has been subjected to the test cutting, processing traces formed by the test cutting are checked. The processing traces can be checked, for example, by imaging the cut grooves by the alignment unit 7, and whether the processing traces are good or bad is evaluated by the number of chippings, the width of the cut grooves, the processing time, stability of the results of processing, and the like. The checking and the evaluation make it possible to find out the appropriate processing conditions for the wafer W (processing condition setting step).

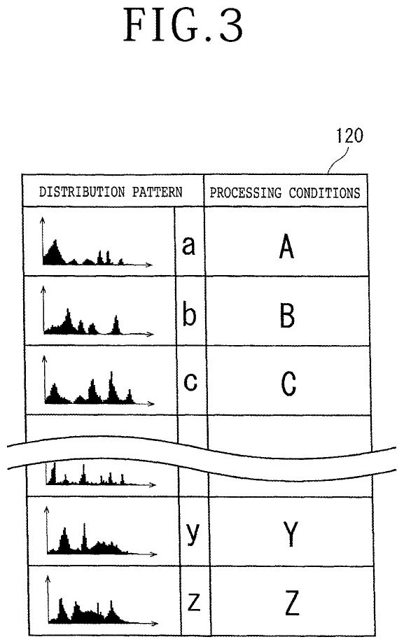

When the distribution pattern generating step and the processing condition setting step have been carried out as described above, the distribution pattern a generated by the distribution pattern generating step and appropriate processing conditions A set by the processing condition setting step are recorded, in a linked manner, in the recording section 120 disposed in the controller 100 as depicted in FIG. 3 (recording step). Note that it is sufficient for the distribution pattern generating step, the processing condition setting step, and the recording step described above to be carried out one time for the wafers formed from the same ingot.

The distribution pattern generating step, the processing condition setting step, and the recording step described above can be carried out each time of processing each of the wafers formed from different blank materials, but, in the case where a plurality of kinds of wafers supposed to be processed can be preliminarily prepared, these steps can be carried out in the gross before carrying out the processing step described later. In that case, a dummy wafer not formed with devices may also be adopted. FIG. 3 depicts the recording section 120 in which the distribution patterns “a” to “z” obtained preliminarily by carrying out the distribution pattern generating step, the processing condition setting step, and the recording step and the appropriate processing conditions A to Z corresponding respectively to the distribution patterns “a” to “z” are recorded and stored in a linked manner, for 26 kinds of semiconductor wafers different in the kind of the substance with which the wafer is doped, the proportion, and/or the ingot manufacturing step.

In a state in which the distribution patterns “a” to “z” and the appropriate processing conditions A to Z corresponding thereto are recorded in a linked manner in the recording section 120 of the controller 100, a wafer W′ to be newly processed is conveyed to the cutting apparatus 1 depicted in FIG. 1, and the wafer W′ is mounted on and held under suction by the holding surface 22a of the chuck table 22. Next, the above-mentioned feeding mechanism is operated to position the wafer W′ directly under the distribution pattern generating unit 9 (partly omitted), as depicted in FIG. 4, and the pulsed laser beam LB1 that causes ablation is applied to the wafer W′ to thereby generate the plasma light PB0. In this instance, the pulsed laser beam LB1 is applied to the peripheral surplus region of the wafer W′ where the devices are not formed. The plasma light PB0 is led through the condenser lens 96 to the diffraction grating 97 that spectrally disperses the plasma light PB0 into its components by wavelength, and the spectra PB1 having been spectrally dispersed by wavelength are generated and outputted to the line sensor 98 by the diffraction grating 97. Based on the spectra PB1 outputted to the line sensor 98, the distribution pattern “a” including the wavelength and intensity of the light intrinsic of the substance constituting the wafer W′ as displayed on the display unit 14 in FIG. 4 is generated.

When the distribution pattern “a” has been generated as described above, the distribution pattern “a” and the distribution patterns “a” to “z” recorded in the recording section 120 are collated, and the distribution pattern having a degree of similarity to the distribution pattern “a” in an allowable range is selected by the distribution pattern selecting section 130 disposed in the controller 100 (distribution pattern selecting step). The distribution pattern selecting step can be realized, for example, by pattern matching, and the distribution pattern that is evaluated by the pattern matching to have a degree of similarity in an allowable range (for example, the evaluation of the degree of similarity is not less than 85%) and have the highest degree of similarity is selected. In the present embodiment, as the distribution pattern that has a degree of similarity to the distribution pattern “a” in the allowable range and has the highest degree of similarity, for example, the distribution pattern y recorded in the recording section 120 depicted in FIG. 3 is selected (distribution pattern selecting step).

When the distribution pattern “y” has been selected by the distribution pattern selecting step, the processing conditions Y linked to the distribution pattern “y” are selected, and the processing conditions Y are set as the processing conditions used at the time of cutting the wafer W′ in the cutting apparatus 1. Note that the degree of similarity to the distribution pattern “a” being in the allowable range in the above-described distribution pattern generating step means such a range of the allowable degree of similarity that, by selecting the distribution pattern stored in the recording section 120 as being high in the degree of similarity, the processing conditions are set for the workpiece deemed as being formed from the same blank material and the appropriate processing is carried out.

When the processing conditions Y have been set as the processing conditions for the wafer W′ as described above, alignment is performed by the alignment unit 7 to detect the street L of the wafer W′, and, in reference to the positional information of the street L detected, the cutting unit 8 and the above-mentioned feeding mechanism are operated to cut the wafer W′ along all the streets L to divide the wafer W′ into the individual device chips, whereby the processing step is completed (the details are omitted).

The processing of the wafer W′ described above is carried out while the appropriate processing conditions are selected from the processing conditions preliminarily stored by the distribution pattern generating step, the processing condition setting step, and the recording step, so that the processing is one that is carried out according to the characteristics such as the hardness, brittleness, and flexibility of the silicon substrate which vary according to the kind and amount of the impurity with which the blank material constituting the wafer W′ is doped with, the ingot manufacturing method, and the like, whereby the problem that the processing conditions must be searched for each time of a change in the characteristics of the workpiece causing poor productivity and troublesome work is dissolved.

Further, in a case where, even when the distribution pattern “a” of the wafer W′ to be processed that has been generated in the distribution pattern selecting step described above ad the distribution patterns “a” to “z” recorded in the recording section 120 are collated, the allowable range in which a high degree of similarity is found cannot be satisfied, and the processing conditions A to Z linked with the distribution patterns “a” to “z” cannot be selected as the appropriate processing conditions, the abovementioned processing condition setting step is carried out again for the wafer W′, and the newly found appropriate processing conditions and the distribution pattern “a” are recorded and stored in a linked manner in the recording section 120. Repeating such a process makes it possible to gradually increase distribution patterns and appropriate processing conditions and effectively use previous appropriate processing conditions, despite small amounts of distribution patterns and appropriate processing conditions linked thereto accumulated in advance in the recording section 120, thus solving the problem that the processing conditions must be searched for each time of a change in the characteristics of the workpiece causing poor productivity and significantly troublesome work.

In the processing method for the workpiece of the present invention, it is not necessarily limitative that the distribution patterns and the appropriate processing conditions linked to the distribution patterns are preliminarily recorded in a linked manner in the recording section 120. For example, even in the case where the distribution patterns and the appropriate processing conditions linked to the distribution patterns are not at all recorded in the above-mentioned recording section 120, it is sufficient to record the distribution pattern and the appropriate processing conditions linked to the distribution pattern, by performing the distribution pattern generating step, the processing condition setting step, and the recording step, each time processing of a new wafer is carried out.

In addition, in the above-described embodiment, when the distribution pattern generated based on the workpiece and the distribution patterns recorded in the recording step are collated to collate the degree of similarity, the degree of similarity has been detected by pattern matching, but the present invention is not limited to this configuration, and the process can also be carried out by deep learning. In addition, the distribution pattern generated in the distribution pattern generating step of the above-described embodiment has been displayed in a two-dimensional graph in which the axis of abscissas expresses the wavelength and the axis of ordinates expresses the light intensity, but the present invention is not limited to this configuration. In the case where the pulsed laser beam that causes ablation is applied to the workpiece to generate the plasma light, the plasma light has its wavelength components varying with the lapse of time according to the characteristics intrinsic of the substance constituting the workpiece. Hence, a three-dimensional graph including time as a parameter in addition to the wavelength and the light intensity may be displayed. In the case where the distribution pattern is thus displayed in the form of the three-dimensional graph, the amount of information at the time of collating the distribution pattern generated based on the workpiece and the distribution patterns recorded in the recording step to collate the degree of similarity is large, so that the collation utilizing deep learning is more effective.

In the embodiment described above, there has been described the processing method in which cutting is carried out by applying the present invention to the cutting apparatus that performs cutting, but the present invention is not limited to this configuration. For example, the processing apparatus of the present invention can be applied to a laser processing apparatus, and the processing conditions linked to the distribution pattern can be made to be processing conditions at the time of subjecting the workpiece to laser processing. In that case, as the processing conditions recorded in the form of being linked to the distribution patterns, for example, the wavelength, the average output, the repetition frequency, and the pulse width of the laser beam, the processing feed rate, and the like are recorded in the recording section 120 in the form of being linked to the distribution patterns. Further, the present invention can also be applied to a grinding apparatus that performs grinding, and the processing conditions linked to the distribution pattern selected in the distribution pattern selecting step can be made to be processing conditions used at the time of subjecting the workpiece to grinding.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A processing method for a workpiece, comprising:
a distribution pattern generating step of applying, to the workpiece, such a pulsed laser beam as to cause ablation to generate plasma light and generating a first distribution pattern including a wavelength and intensity of light intrinsic of a substance constituting the workpiece, according to the plasma light;
a processing condition setting step of finding and setting appropriate processing conditions for processing the workpiece;
a recording step of recording the first distribution pattern generated by the distribution pattern generating step and the processing conditions set by the setting step in a linked manner;
a distribution pattern selecting step of applying, to the workpiece to be processed, such a pulsed laser beam as to generate ablation to thereby generate plasma light, generating a second distribution pattern including a wavelength and intensity of light intrinsic of the substance constituting the workpiece, according to the plasma light, and collating the second distribution pattern and the first distribution pattern recorded in the recording step to thereby select a third distribution pattern having a degree of similarity in an allowable range; and
a processing step of processing the workpiece in reference to processing conditions linked to the third distribution pattern selected in the distribution pattern selecting step.

2. The processing method for the workpiece according to claim 1, wherein the workpiece is a plate-shaped workpiece.

3. The processing method for the workpiece according to claim 1, wherein, in the distribution pattern generating step, the pulsed laser beam is applied to an unnecessary part of the workpiece.

4. A processing apparatus for a workpiece, comprising:
a distribution pattern generating unit that applies, to the workpiece, such a pulsed laser beam as to cause ablation to generate plasma light and generate a first distribution pattern including a wavelength and intensity of light intrinsic of a substance constituting the workpiece, according to the plasma light;
a recording section that records the first distribution pattern of the workpiece generated by the distribution pattern generating unit and appropriate processing conditions for processing the workpiece in a linked manner;
a distribution pattern selecting section that generates a second distribution pattern of the workpiece to be processed by the distribution pattern generating unit and collates the second distribution pattern and the first distribution pattern recorded in the recording section to thereby select a third distribution pattern having a degree of similarity in an allowable range; and
a processing unit that processes the workpiece in reference to processing conditions linked to the third distribution pattern selected by the distribution pattern selecting section.

5. The processing apparatus for the workpiece according to claim 4, wherein the workpiece is a plate-shaped workpiece.

6. The processing apparatus for the workpiece according to claim 4, wherein the distribution pattern generating unit is means for applying the pulsed laser beam to an unnecessary part of the workpiece.
